(19) United States
(12) Patent Application Publication
(10) Pub. No.: US 2007/0056168 A1
(43) Pub. Date: Mar. 15, 2007

(54) Chain saw tool holder

(76) Inventor: Michael J. McLaughlin, Del Valle, TX (US)

Correspondence Address: LITMAN LAW OFFICES, LTD, PO BOX 15035, CRYSTAL CITY STATION, ARLINGTON, VA, 22215, US

(21) Appl. No.: 11/520,579

(22) Filed: Sep. 14, 2006

Related U.S. Application Data
(60) Provisional application No. 60/716,981, filed on Sep. 15, 2005.

(51) Int. Cl. B25F 3/00

(52) U.S. Cl. 30/122; 30/383

(57) ABSTRACT

The chain saw tool holder is a device for attaching a conventional chain saw adjustment tool to the chain guide bar attachment points of a chain saw for convenient access to the tool. The holder includes a chain guide bar fitting attachment plate and a tool shank holder opposite the attachment plate. The attachment plate may have any of several configurations to provide for removable attachment to various models of chain saws. The tool shank holder may comprise a tube into which the shank of the tool is inserted axially, or may comprise a channel into which the shank of the tool is inserted laterally. All of the tool shank holders include some form of tool retaining device therein or therewith to secure the tool positively within the device until use of the tool is desired.

### CROSS-REFERENCE TO RELATED APPLICATION

This application claims the benefit of U.S. Provisional Patent Application Ser. No. 60/716,981, filed Sep. 15, 2005.

### BACKGROUND OF THE INVENTION

1. Field of the Invention

The present invention relates generally to brackets, clips, and similar devices for removably securing an article or accessory to another object. More specifically, the present device is a chain saw (sometimes spelled “chainsaw”) tool holder that attaches to a chain saw using the conventional chain guide bar attachment bolts or fittings, and that removably secures a conventional chain saw adjustment tool therein for convenient access when needed.

2. Description of the Related Art

Chain saws powered by either electric motors or internal combustion engines are popular power tools for performing a variety of relatively heavy-duty cutting operations. Such saws are not limited only to cutting trees, firewood, and similar material. Many specialized chain saws have been developed for cutting concrete and other hard materials as well. However, the general mechanism and principle of operation remains essentially the same for practically all chain saws.

All such chain saws include a chain guide bar, with the cutting chain running around the periphery of the bar. An endless roller-type chain with the chain links having cutting teeth extending therefrom is used, and a chain drive sprocket within the case or housing of the saw drives the chain. Roller chains are well known for requiring periodic adjustment due to the wear between the link pins, link stretching, and other factors. Accordingly, the chain and bar assembly requires periodic adjustment in order to maintain proper tension on the chain.

The vast majority of chain saws provide relatively easy chain tension adjustment by adjusting the chain guide bar longitudinally relative to the chain drive sprocket to increase or decrease the total length of the chain path. Most such saws require that the (usually) two nuts be loosened which secure the guide bar to the frame or main structure of the saw, and the bar be adjusted forwardly or rearwardly by means of a tool that engages a toothed rack or other mechanism. Thus, a socket for loosening and tightening the guide bar attachment nuts, and a blade for engaging the bar adjustment, are required for the vast majority of chain saws.

These tools are conventionally provided as a single combination device having a generally T-shaped configuration, with a different socket size in each end of a tubular component forming the crossbar of the T and a blade shank and blade extending from the central portion of the socket tube forming the stem of the T. Each component serves as a lever for applying force to the other component. Such tools are conventional, as noted above, and are frequently required in the field for saw adjustment during use.

A problem occurs in retaining the tool close at hand with the saw. Most chain saws do not include any provision for carrying or retaining the chain adjustment tool with the saw. Rather, such tools tend to be kept with other chain saw maintenance and repair items, such as chain oil and/or oil for mixing with fuel, spare spark plugs, air filters, chain sharpening tools, etc. Thus, the typical user of a chain saw may be likely to leave the chain adjustment tool behind when he or she travels to the field to use the saw, only to have to return to the shop or base to retrieve the tool for a one-minute adjustment job.

Thus, a chain saw tool holder solving the aforementioned problems is desired.

### SUMMARY OF THE INVENTION

The chain saw tool holder comprises a bracket configured for attachment to the saw housing or case by the (usually two) conventional chain guide bar attachment bolts or fittings. The bracket is configured to clear the remaining structure of the saw and includes a tool-retaining component, which places the chain adjuster tool conveniently for access by the user of the saw and retains the tool positively in the holder until needed. The holder may be configured for attachment to and use with virtually any chain saw available with only relatively minor modifications. The tool holding and retaining portion may comprise a tubular element into which the shank of the blade portion of the tool is inserted axially, or may comprise a slot or channel into which the shank of the tool is inserted laterally. All embodiments of the present tool holder preferably provide for positively retaining the tool therein, regardless of the attitude or orientation of the saw, until the user positively withdraws the tool from the holder for use.

These and other features of the present invention will become readily apparent upon further review of the following specification and drawings.

### BRIEF DESCRIPTION OF THE DRAWINGS

FIG. 1 is an environmental, perspective view of a first embodiment of a chain saw tool holder according to the present invention, shown attached to a chain saw and holding a chain adjustment tool therein.

FIG. 2 is an exploded perspective view of the chain saw tool holder embodiment of FIG. 1 and a chain saw adjuster tool, showing various details of the tool holder and tool.

FIG. 3 is an environmental perspective view of a second embodiment of a chain saw tool holder according to the present invention.

FIG. 4 is an exploded perspective view of a third embodiment of a chain saw tool holder according to the present invention.

FIG. 5 is a perspective view of a fourth embodiment of a chain saw tool holder according to the present invention.

FIG. 6 is a perspective view of a fifth embodiment of a chain saw tool holder according to the present invention.

Similar reference characters denote corresponding features consistently throughout the attached drawings.

### DETAILED DESCRIPTION OF THE PREFERRED EMBODIMENTS

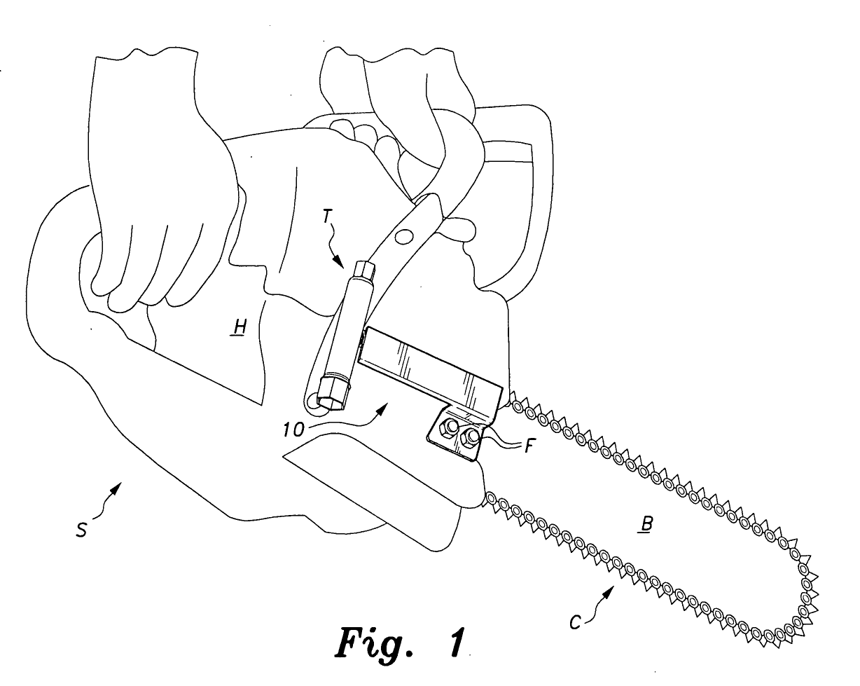

The present invention comprises a series of embodiments of a chain saw tool holder configured for removable attachment to a conventional chain saw and for removably holding a conventional chain adjusting tool therein for convenient access by the user of the saw. FIG. 1 of the drawings illustrates a first embodiment a chain saw tool holder, designated as 10 in the drawings, removably secured in place upon a conventional chain saw S. Such chain saws S conventionally include a housing H having a chain guide bar B adjustably extending therefrom, with an endless toothed cutting roller chain C extending about the periphery of the guide bar B. The chain C is driven by a drive sprocket and clutch assembly (not shown, but conventional) contained within the saw housing H adjacent the base or attachment end of the guide bar B.

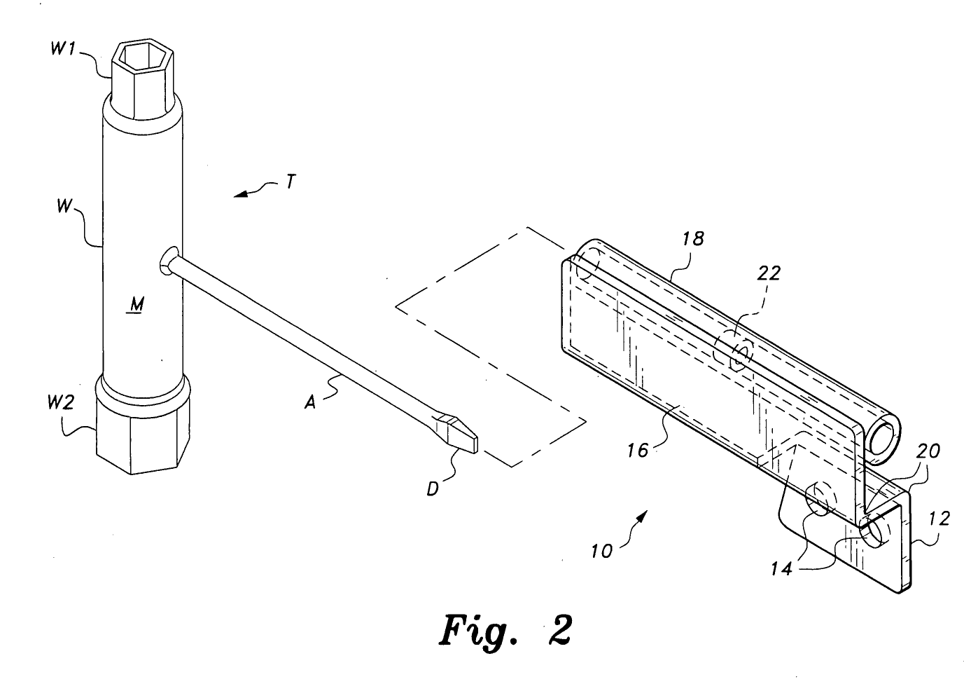

Such roller chains C tend to elongate during use, due to wear of the pins between links and stretching of the links themselves. This requires adjustment of the guide bar B relative to the sprocket in order to keep the chain C tightly extended about the periphery of the guide bar B. This is accomplished by loosening the conventional threaded nuts secured to the guide bar attachment studs, with the hold down nuts and their mating studs comprising an attachment fitting F that is used for attachment of the guide bar B and for attachment of the tool holder 10 of the present invention, and thereafter adjusting the position of the guide bar B slightly by means of a tool. Conventionally, combination tools, such as the tool T shown partially in FIG. 1 and in detail in FIGS. 2-5, are provided for such chain adjustment. The first embodiment of the chain saw tool holder 10, as well as the other embodiments of the tool holder described below, is removably attached to the bar attachment fitting F by one or more cooperating passages formed through the holder 10 for installation over the hold down studs of the fitting F on the saw S.

FIG. 2 provides a detail view of the first embodiment chain saw tool holder 10 of FIG. 1, as well as a complete view of an exemplary chain adjustment tool T. The tool holder 10 includes an attachment plate 12, which forms a base for the remainder of the tool holder 10. The attachment plate 12 includes at least one attachment passage 14 formed therethrough, with the number and configuration of attachment passages depending upon the specific make and model of saw S with which the tool holder 10 is to be used. Attachment to the vast majority of saws may be provided by a pair of holes or passages 14, as shown in FIG. 2, with illustrations of other embodiments showing other attachment passage configurations. The attachment passages 14 may also be non-circular, e.g. oval slots, if so desired, or a single oval slot and single round hole may be provided, as desired.

A medial plate portion 16 extends from the attachment plate 12 to a distal edge having a chain adjustment tool retainer 18 disposed thereon. The medial plate portion 16 may include a pair of mutually opposed offset bends 20 formed therein, serving to offset or displace the tool retainer 18 from the plane of the attachment plate 12. This provides clearance for the tool retainer 18 from the case or housing H of the chain saw S when the attachment fitting(s) F are somewhat recessed in the side of the housing H, as in the exemplary chain saw S of FIG. 1.

The attachment plate 12 and medial plate portion 16 of the tool holder 10 may be formed of a single, continuous sheet of material (e.g., aluminum or steel sheet metal, etc.), with the tool retainer 18 being formed of a separate metal tube welded (or otherwise permanently secured) to the distal edge of the medial plate 16. Alternatively, the attachment plate 12, medial plate portion 16, and tool retainer 18 may be formed (e.g., cast, extruded, etc.) from a single, monolithic piece of sturdy plastic or other durable material. The tool retainer tube 18 preferably includes a chain adjustment tool grip 22 immovably affixed within the tube 18, with the grip 22 of the tool holder embodiment of FIGS. 1 and 2 comprising a grommet or ring formed of a slightly resilient material (e.g., nylon or other suitable plastic or elastomeric material) in order to deform slightly to accept and retain the blade of the tool T when it is inserted into the tool retainer tube 18.

The chain saw chain adjustment tool T is conventional, as noted further above. The tool T includes a tubular socket wrench portion W having a first wrench end W1 and a second wrench end W2, with a medial portion M extending between the two wrench ends W1 and W2. The wrench ends W1 and W2 are preferably of different sizes in order to accommodate different fastener sizes for different saw fittings F. An elongate adjuster blade shank A extends from the medial portion M of the wrench portion W essentially normal to the axis of the wrench portion W. The wrench portion W and blade shank A thus form a T configuration, with the wrench portion W of the tool T forming the crossbar of the T, and the blade shank A forming the stem. The blade shank A includes a distal end having a chain tension adjuster blade D extending therefrom. The blade D is slightly wider than the diameter of the blade shank A, as is conventional with standard screwdriver blades. The slightly wider blade D provides an interference fit within the tool grip 22 inside the tool retaining tube 18, distending the resilient tool grip 22 as the blade D passes therethrough, with the tool grip 22 restraining the wider blade D within the tube 18 until the user of the tool applies a positive force to withdraw the tool T from its storage position within the tool retainer tube 18 of the tool holder 10.

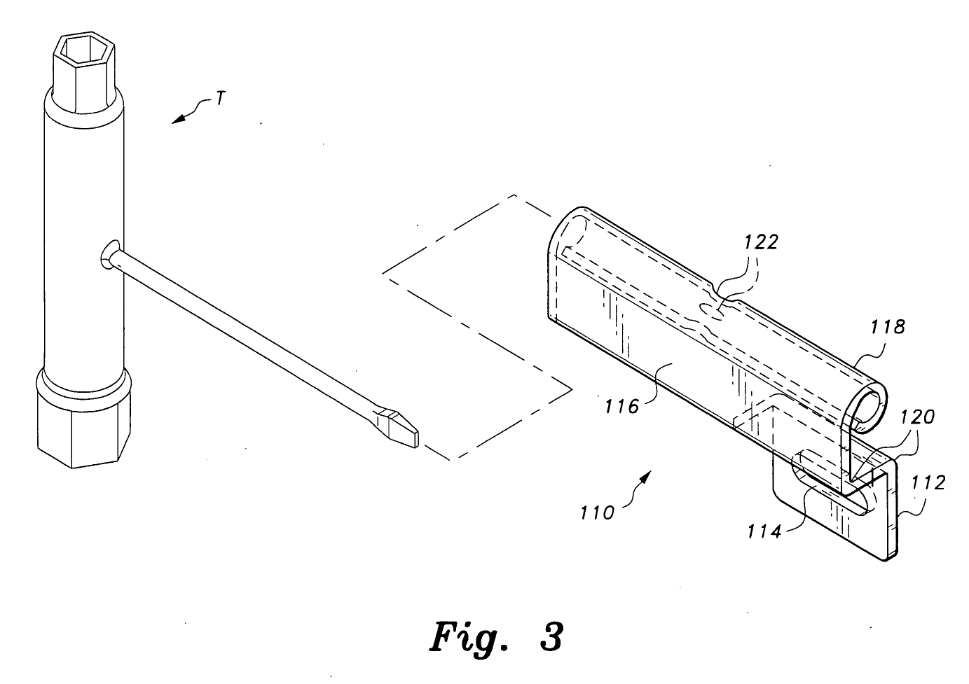

FIG. 3 of the drawings illustrates a second embodiment of the present chain saw tool holder, designated as tool holder 110. The tool holder 110 includes an attachment plate 112, configured similarly to the attachment plate 12 of the tool holder embodiment 10 of FIGS. 1 and 2. However, rather than having plural fitting holes or passages therethrough, the attachment plate 112 has a single elongated slot 114 formed therethrough. This allows for different spacing between the chain guide bar attachment studs of different makes and models of chain saws, without the need for precisely spaced discrete holes or passages through the attachment plate 112.

The tool holder 110 of FIG. 3 includes a medial plate portion 116 extending from the attachment plate 112, as in the first embodiment of FIGS. 1 and 2. The medial plate portion 116 may also include a pair of opposed offset bends 120, and extends to a distal edge having a chain adjustment tool retainer 118 extending therealong. However, the tool retainer 118 is formed somewhat differently than the tool retainer 18 of the first embodiment, which was illustrated in detail in FIG. 2. In the tool holder 110 of FIG. 3, the tool retainer 118 is rolled as a continuous, integral extension of the same sheet of material that forms the medial plate portion 116 and attachment plate 112 of the device 110. This may result in certain advantageous economies of manufacture. The tool grip portion 122 within the rolled tool retainer tube 118 may comprise a resilient ring or grommet, as in the first embodiment shown in FIG. 2, but the embodiment of FIG. 3 also includes one or more dimples or depressions 122 formed in the sides of the rolled tube 118 to secure the blade D of the chain adjustment tool T within the tube 118. By forming the dimples or depressions 122 to a precisely predetermined depth, the slight interference between the inner walls of the dimples 122 and the width of the blade D will result in the retention of the tool T by the tool holder 110, yet provide sufficient springback or expansion to allow the blade D to be withdrawn from and inserted past the dimples or depressions 122, particularly in the case of a rolled tube 118 where the roll may be expanded slightly by the internal pressure of the blade D therein.

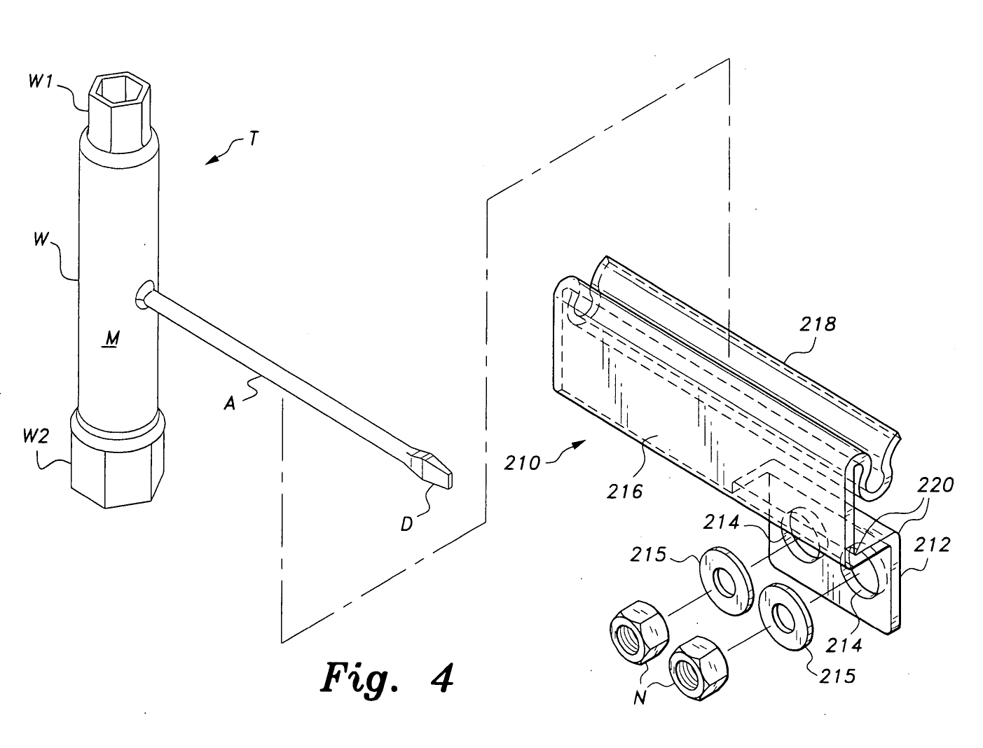

FIG. 4 of the drawings illustrates a third embodiment of the chain saw tool holder, designated as tool holder 210. The tool holder 210 includes an attachment plate 212, configured similarly to the attachment plate 12 of the tool holder 10 of FIGS. 1 and 2. However, rather than having a plurality of relatively small fitting holes or passages therethrough, the attachment plate 212 has a pair of enlarged holes or passages 214 formed therethrough. This allows for different spacing between the chain guide bar attachment studs of different makes and models of chain saws, without the need for a precisely sized holes or passages through the chain guide bar fitting. A corresponding pair of large diameter washers 215 overlap the edges of the large holes 214 while providing smaller internal holes, which closely fit the conventional threaded studs (not shown) of the attachment fitting F of the chain saw. Conventional threaded nuts N secure to the threaded studs of the attachment fitting F to secure both the chain guide bar and the chain saw tool holder 210 to the chain saw.

The tool holder 210 of FIG. 4 includes a medial plate portion 216 extending from the attachment plate 212, as in the first embodiment of FIGS. 1 and 2. The medial plate portion 216 may also include a pair of opposed offset bends 220, and extends to a distal edge having a chain adjustment tool retainer 218 extending therealong. However, the tool retainer 218 is formed somewhat differently than the tool retainer 18 of the tool holder 10 shown in FIG. 2, as well as the tool retainer 118 of tool holder 110, shown in FIG. 3. In the tool holder 210 of FIG. 4, the tool retainer 218 is formed as a laterally open channel into which the blade shank A of the tool T can be inserted laterally. The tool retainer channel 218 is preferably formed as a continuous, integral extension of the same sheet of material used to form the medial plate portion 216 and attachment plate 212 of the device 210 with advantageous economy of manufacture. The tool grip within the tool retainer channel 218 is provided by the relatively narrow opening of the channel 218 at its outer lip, with the material used to form the tool holder 210 providing sufficient resilience and springback to grip the tool shank A securely while still allowing the channel 218 to be spread slightly for removal and insertion of the tool shank A from and into the channel 218, as required.

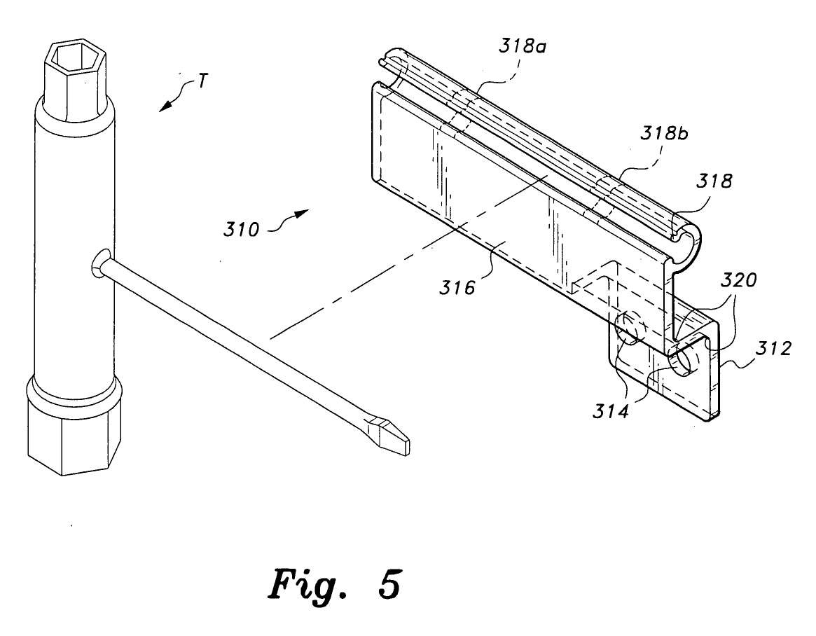

FIG. 5 of the drawings illustrates a fourth embodiment of the present chain saw tool holder, designated as tool holder 310. The tool holder 310 includes an attachment plate 312 configured similarly to the attachment plates of other tool holder embodiments disclosed above. The attachment plate 312 has a pair of holes or passages 314 formed therethrough sized to fit closely the conventional chain guide bar attachment studs or fittings F of most saws. Alternatively, any of the attachment plates 12, 112, or 212 could be used with the embodiment of FIG. 5, if so desired. Conventional threaded nuts, as shown in FIG. 4, secure to the threaded studs of the attachment fitting F to secure both the chain guide bar and the chain saw tool holder 310 to the chain saw.

The tool holder 310 of FIG. 5 includes a medial plate portion 316 extending from the attachment plate 312, as in the other embodiments. The medial plate portion 316 may also include a pair of opposed offset bends 320, and extends to a distal edge having a chain adjustment tool retainer 318 extending therealong. The tool retainer 318 is formed similarly to the tool retainer 218 of the third embodiment 210 of FIG. 4, i.e., stamped, rolled, extruded, or otherwise formed as an open channel. However, rather than orienting the mouth of the tool retainer channel 318 so that the tool shank A is inserted parallel to the plane of the attachment plate 312, the tool retainer channel 318 is turned 90° so that the tool shank A is inserted into and withdrawn from the channel 318 perpendicular to the plane of the attachment plate 312. Otherwise, the tool retainer channel 318 is formed in the same manner as the channel 218 of the tool holder 210 of FIG. 4, i.e., preferably formed as a continuous, integral extension of the same sheet of material used to form the medial plate portion 316 and attachment plate 312 of the device 310. The tool grip within the tool retainer channel 318 is provided by the relatively narrow opening of the channel 318 at its outer lip, with the material used to form the tool holder 310 providing sufficient resilience and springback to grip the tool shank A securely while still allowing the channel 318 to be spread slightly for removal and insertion of the tool shank A from and into the channel 318, as required. FIG. 5 also shows an alternative embodiment which may be adapted to any of the other embodiments of the present invention, with the tool retainer channel 318 alternatively formed as a pair of relatively short clips 318a and 318b, shown in broken lines in FIG. 5. The cross-sectional shape of the short clips 318a and 318b is the same as that of the full length channel 318.

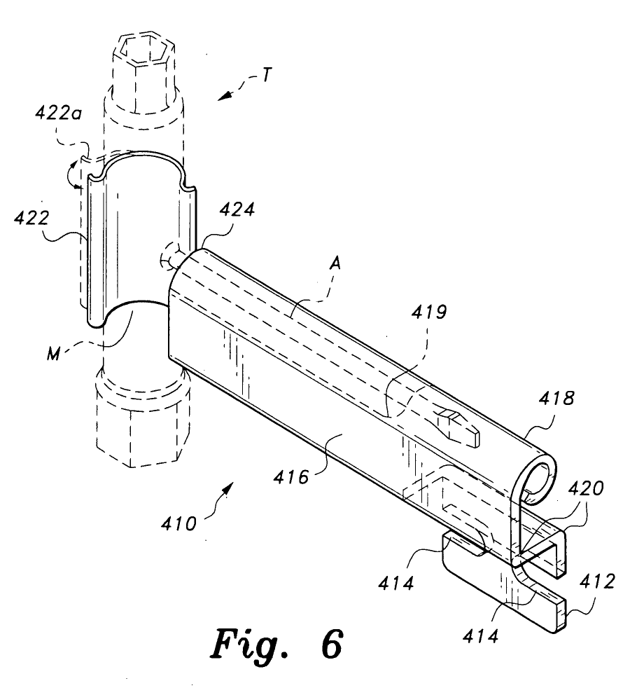

FIG. 6 of the drawings illustrates a fifth embodiment of the present chain saw tool holder, designated as tool holder 410. The tool holder 410 includes an attachment plate 412 configured similarly to the attachment plates of other tool holder embodiments disclosed above, but including a pair of opposed open ended slots 414 formed therethrough. Such slots 414 permit the attachment plate 412 to be slid into position on the saw by merely loosening one bolt, rather than requiring the removal of both bolts. The slots 414 may be lengthened or shortened as desired, or formed at a different angle(s) than shown in FIG. 6, as desired. It will also be seen that a single slot 414 may be provided, with the other attachment passage being a hole as shown in other drawing Figs.

The tool holder 410 of FIG. 6 includes a medial plate portion 416 extending from the attachment plate 412, as in the other embodiments. The medial plate portion 416 may also include a pair of opposed offset bends 420, and extends to a distal edge having a chain adjustment tool retainer 418 extending therealong. The tool retainer 418 is formed similarly to the tool retainer 118 of the fourth embodiment 110 of FIG. 3, i.e., rolled, but it may be stamped, extruded, or otherwise formed as an open channel, if so desired. The tool retainer channel 418 is preferably formed as a continuous, integral extension of the same sheet of material used to form the medial plate portion 416 and attachment plate 412 of the device 410, but may be formed as a shorter tubular length if so desired, as indicated by the broken line edge 419 showing the portion of the longer tube which may be cut away to form a shorter sleeve or tube.

The chain saw tool holder 410 of FIG. 6 differs from other embodiments in that a separate spring clip portion 422 extends from the insertion end 424 of the tool retainer tube 418, and orthogonally relative to the tube 418. The spring clip 422 may be riveted, welded, or otherwise attached to the insertion end of the tube 418, or may have an extension attaching it to the medial plate 416 where the tube 418 has been shortened. The clip 422 is curved to fit closely about the medial portion M of the chain saw tool T, and to grip the medial portion M or barrel of the tool T when the tool is inserted into the tool holder 410. The closely conforming shape of the clip 422 prevents the rotation of the tool T within the holder 410 about the blade shank A of the tool, as well as preventing the tool T from sliding axially from its stored location within the tool holder. However, the resilient spring clip 422 may be flexed to allow for the installation or removal of the tool T into or from the holder 410, as indicated by the alternative broken line position 422a of the distal edge of the clip 422 in FIG. 6.

In conclusion, the chain saw tool holder, in any of the various embodiments described, provides a greatly needed means of keeping and retaining a conventional chain saw tool readily at hand during chain saw operations. The tool holder assures that the tool is retained physically with the chain saw at all times, rather than being left behind inadvertently when the user of the saw takes the saw to the field for work. The attachment of the tool holder at the chain blade attachment and adjustment fitting(s) positions the holder along the right side of the saw, where it is readily accessible by the right hand of the saw user. Accordingly, the chain saw tool holder in its various embodiments will prove to be a desirable means of keeping a conventional chain saw tool close at hand while the chain saw is in use.

It is to be understood that the present invention is not limited to the embodiments described above, but encompasses any and all embodiments within the scope of the following claims.

I claim:

1. A chain saw tool holder, comprising:
an attachment plate adapted for attachment to a chain saw bar guide fitting, the attachment plate having at least one chain guide bar fitting attachment passage defined therein; and
a chain adjustment tool retainer adapted for receiving a chain saw adjustment tool, the retainer being opposite the attachment plate and extending therefrom.

2. The chain saw tool holder according to claim 1, further including a medial plate portion extending between said chain guide bar fitting attachment plate and said chain adjustment tool retainer, the medial plate portion having a pair of mutually opposed offset bends displacing said chain adjustment tool retainer from said attachment plate so that said retainer is offset from said attachment plate.

3. The chain saw tool holder according to claim 1, wherein said chain adjustment tool retainer is selected from the group consisting of a tube and a laterally open channel.

4. The chain saw tool holder according to claim 1, further including a chain adjustment tool grip disposed within said chain adjustment tool retainer.

5. The chain saw tool holder according to claim 1, wherein the at least one chain guide bar fitting attachment passage comprises two spaced apart holes extending completely through said chain guide bar fitting attachment plate.

6. The chain saw tool holder according to claim 1, wherein the at least one chain guide bar fitting attachment passage comprises a single elongated slot extending completely through said chain guide bar fitting attachment plate.

7. The chain saw tool holder according to claim 1, further including:
a chain saw adjustment tool removably disposed within said chain adjustment tool retainer; and
a chain saw having a chain guide bar fitting, said chainsaw tool holder being removably secured to the chain guide bar fitting.

8. A chain saw tool holder in combination with a chain saw chain adjustment tool, comprising:
a chain saw tool holder, the holder having:
an attachment plate adapted for attachment to a chain saw bar guide fitting, the attachment plate having at least one chain guide bar fitting attachment passage defined therein; and
a chain adjustment tool retainer adapted for receiving a chain saw adjustment tool, the retainer being opposite the attachment plate and extending therefrom;
a chain saw chain adjustment tool, the tool having;
a tubular socket wrench portion having a first end, a second end opposite the first end, and a medial portion therebetween;
an elongate adjuster blade shank extending from the medial portion of the socket wrench portion, the shank having a distal end and a chain tension adjuster blade extending from the distal end, the adjuster blade shank being removably stored within the chain adjustment tool retainer.

9. The chain saw tool holder and chain saw adjustment tool combination according to claim 8, wherein said holder further comprises a medial plate portion extending between said chain guide bar fitting attachment plate and said chain adjustment tool retainer, the medial plate portion having a pair of mutually opposed offset bends displacing said retainer from said attachment plate.

10. The chain saw tool holder and chain saw adjustment tool combination according to claim 8, wherein said chain adjustment tool retainer is selected from the group consisting of a tube and a laterally open channel.

11. The chain saw tool holder and chain saw adjustment tool combination according to claim 8, further including a chain adjustment tool grip disposed within said chain adjustment tool retainer.

12. The chain saw tool holder and chain saw adjustment tool combination according to claim 8, wherein the at least one chain guide bar fitting attachment passage comprises two spaced apart holes extending completely through said chain guide bar fitting attachment plate.

13. The chain saw tool holder and chain saw adjustment tool combination according to claim 8, wherein the at least one chain guide bar fitting attachment passage comprises a single elongated slot extending completely through said chain guide bar fitting attachment plate.

14. The chain saw tool holder and chain saw adjustment tool combination according to claim 8, further including a chain saw having a chain guide bar fitting, said tool holder being removably secured to the fitting.

15. A chain saw tool holder, chain saw, and chain saw adjustment tool, comprising in combination:
a chain saw having a housing with a chain guide bar adjustably extending therefrom and a toothed cutting chain extending peripherally around the chain guide bar, the housing having a chain guide bar fitting adjustably securing the chain guide bar to the housing;
a chain saw tool holder, the holder having:
an attachment plate removably attached to the guide bar fitting, the attachment plate having at least one chain guide bar fitting attachment passage defined therein; and
a chain adjustment tool retainer, the retainer being opposite the attachment plate and extending therefrom; and
a chain saw chain adjustment tool, the tool having;
a tubular socket wrench portion having a first end, a second end opposite the first end, and a medial portion therebetween;
an elongate adjuster blade shank extending from the medial portion of the socket wrench portion, the shank having a distal end and a chain tension adjuster blade extending from the distal end, the adjuster blade shank being removably stored within the chain adjustment tool retainer.

16. The chain saw, chain saw tool holder, and chain saw adjustment tool combination according to claim 15, wherein said holder further comprises a medial plate portion extending between said chain guide bar fitting attachment plate and said chain adjustment tool retainer, the medial plate portion having a pair of mutually opposed offset bends displacing said retainer from said attachment plate so that said retainer is offset from said guide bar when said holder is attached to said chain saw.

17. The chain saw, chain saw tool holder, and chain saw adjustment tool combination according to claim 15, wherein said chain adjustment tool retainer is selected from the group consisting of a tube and a laterally open channel.

18. The chain saw, chain saw tool holder, and chain saw adjustment tool combination according to claim 15, further including a chain adjustment tool grip disposed within said chain adjustment tool retainer.

19. The chain saw, chain saw tool holder, and chain saw adjustment tool combination according to claim 15, wherein the at least one chain guide bar fitting attachment passage comprises two spaced apart holes extending completely through said chain guide bar fitting attachment plate.

20. The chain saw, chain saw tool holder, and chain saw adjustment tool combination according to claim 15, wherein the at least one chain guide bar fitting attachment passage comprises a single elongated slot extending completely through said chain guide bar fitting attachment plate.
